(19) United States
(12) Patent Application Publication
(10) Pub. No.: US 2014/0201045 A1
(43) Pub. Date: Jul. 17, 2014

(54) DETERMINING LOCAL TAX STRUCTURES IN AN ACCOUNTING APPLICATION THROUGH USER CONTRIBUTION

(71) Applicants: Yogish Pai, Santa Clara, CA (US); Anil Sharma, Bangalore (IN); Shirish Kishore Peshwe, Bangalore (IN); Anshu Verma, Bangalore (IN); Richard Ernest Blitz, Victoria (CA)

(72) Inventors: Yogish Pai, Santa Clara, CA (US); Anil Sharma, Bangalore (IN); Shirish Kishore Peshwe, Bangalore (IN); Anshu Verma, Bangalore (IN); Richard Ernest Blitz, Victoria (CA)

(21) Appl. No.: 13/744,108

(22) Filed: Jan. 17, 2013

(51) Int. Cl. G06Q 40/00

(52) U.S. Cl. CPC G06Q 40/103
USPC 705/31

(57) ABSTRACT

A method to generate a suggested tax structure in a software application for a geographical region. The method includes obtaining tax structures generated by users according to a tax jurisdiction requirement of the geographical region, where each tax structure includes a tax rate used by the users to configure instantiations of the software application to perform a task, generating a statistical measure of the users and a number of times the task is performed by the users, generating, in response to the statistical measure exceeding a threshold, a suggested tax structure to represent a portion of the tax structures that is qualified based on the statistical measure, and presenting, in response to determining that a new user of the software application is within the geographical region, the suggested tax structure to the new user.

### SUMMARY

In general, in one aspect, the invention relates to a method to generate a suggested tax structure in a software application for a geographical region. The method includes obtaining a plurality of tax structures generated by a plurality of users according to a tax jurisdiction requirement of the geographical region, wherein each of the plurality of tax structures comprises a tax rate that is used by the plurality of users to configure a plurality of instantiations of the software application for performing a pre-determined task, and wherein performing the pre-determined task within the geographical region comprises at least calculating a tax amount based on the tax rate, generating, by a computer processor, a statistical measure of the plurality of users and a number of times the pre-determined task is performed by the plurality of users, generating, by the computer processor and in response to the statistical measure exceeding a pre-determined threshold, a suggested tax structure to represent a portion of the plurality of tax structures that is qualified based on the statistical measure, and presenting, in response to at least determining that a new user of the software application is within the geographical region, the suggested tax structure to the new user, wherein the suggested tax structure is used by the new user to configure a new instantiation of the software application for performing the pre-determined task within the geographical region.

In general, in one aspect, the invention relates to a system to generate a suggested tax structure in a software application for a geographical region. The system includes (i) a tax structure analyzer executing on a computer processor and configured to obtain a plurality of tax structures generated by a plurality of users according to a tax jurisdiction requirement of the geographical region, wherein each of the plurality of tax structures comprises a tax rate that is used by the plurality of users to configure a plurality of instantiations of the software application for performing a pre-determined task, and wherein performing the pre-determined task within the geographical region comprises at least calculating a tax amount based on the tax rate, generate a statistical measure of the plurality of users and a number of times the pre-determined task is performed by the plurality of users, and generate, in response to the statistical measure exceeding a pre-determined threshold, a suggested tax structure to represent a portion of the plurality of tax structures that is qualified based on the statistical measure, (ii) a user device coupled to the computer processor and configured to present, in response to at least determining that a new user of the software application is within the geographical region, the suggested tax structure to the new user, wherein the suggested tax structure is used by the new user to configure a new instantiation of the software application for performing the pre-determined task within the geographical region, and (iii) a repository configured to store the statistical measure and the suggested tax structure.

In general, in one aspect, the invention relates to a non-transitory computer readable medium storing instructions to generate a suggested tax structure in a software application for a geographical region. The instructions, when executed by a computer processor, comprising functionality for obtain a plurality of tax structures generated by a plurality of users according to a tax jurisdiction requirement of the geographical region, wherein each of the plurality of tax structures comprises a tax rate that is used by the plurality of users to configure a plurality of instantiations of the software application for performing a pre-determined task, and wherein performing the pre-determined task within the geographical region comprises at least calculating a tax amount based on the tax rate, generate a statistical measure of the plurality of users and a number of times the pre-determined task is performed by the plurality of users, generate, in response to the statistical measure exceeding a pre-determined threshold, a suggested tax structure to represent a portion of the plurality of tax structures that is qualified based on the statistical measure, and present, in response to at least determining that a new user of the software application is within the geographical region, the suggested tax structure to the new user, wherein the suggested tax structure is used by the new user to configure a new instantiation of the software application for performing the pre-determined task within the geographical region.

Other aspects of the invention will be apparent from the following detailed description and the appended claims.

### BRIEF DESCRIPTION OF DRAWINGS

FIGS. 1A-1C show schematic diagrams of a system of determining local tax structures in an accounting application through user contribution in accordance with one or more embodiments of the invention.

FIG. 2 shows a flowchart of a method of determining local tax structures in an accounting application through user contribution in accordance with one or more embodiments of the invention.

FIGS. 3A-3D show an example of determining local tax structures in an accounting application through user contribution in accordance with one or more embodiments of the invention.

FIG. 4 shows a diagram of a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In computing, the terms “internationalization” and “localization” refer to adapting computer software to different languages, regional differences, and regulatory requirements of a target market. Internationalization is the process of designing a software application so that the application can be adapted to various regional requirements without substantial engineering changes. Localization is the process of adapting internationalized software for a specific region by adding locale-specific components and translating text based on a language specific to the region. Throughout this disclosure, the term “tax jurisdiction” refers to a region with a set of tax laws under the control of a system of courts or government entity which are different to neighboring regions.

Embodiments of the invention provide suggested localized tax structures of an accounting application by automatically identifying a specific geographic region and industry specific pattern in user created tax structures of the accounting application. In one or more embodiments of the invention, the suggested tax structures are based on statistical measures such as number of registered (paid) users, number of active users, number of active users using a tax structure that matches a particular pattern, number of documents generated by the accounting application using a tax structure that matches a particular pattern, etc.

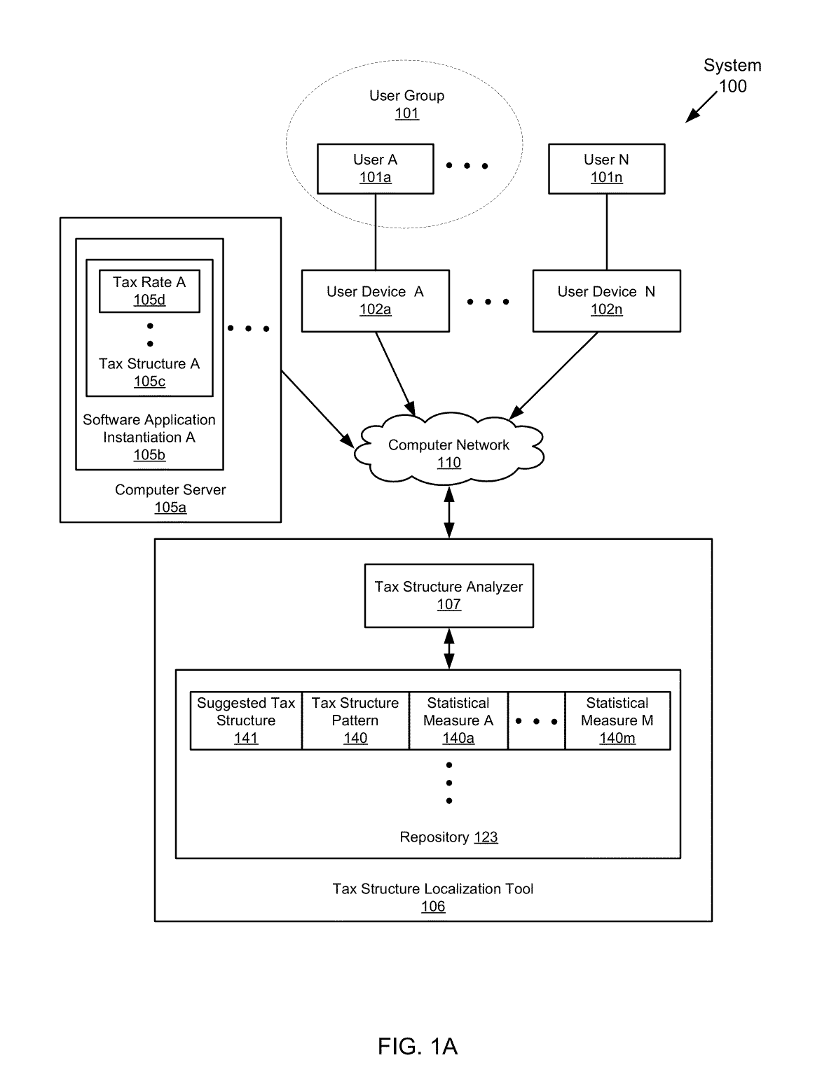

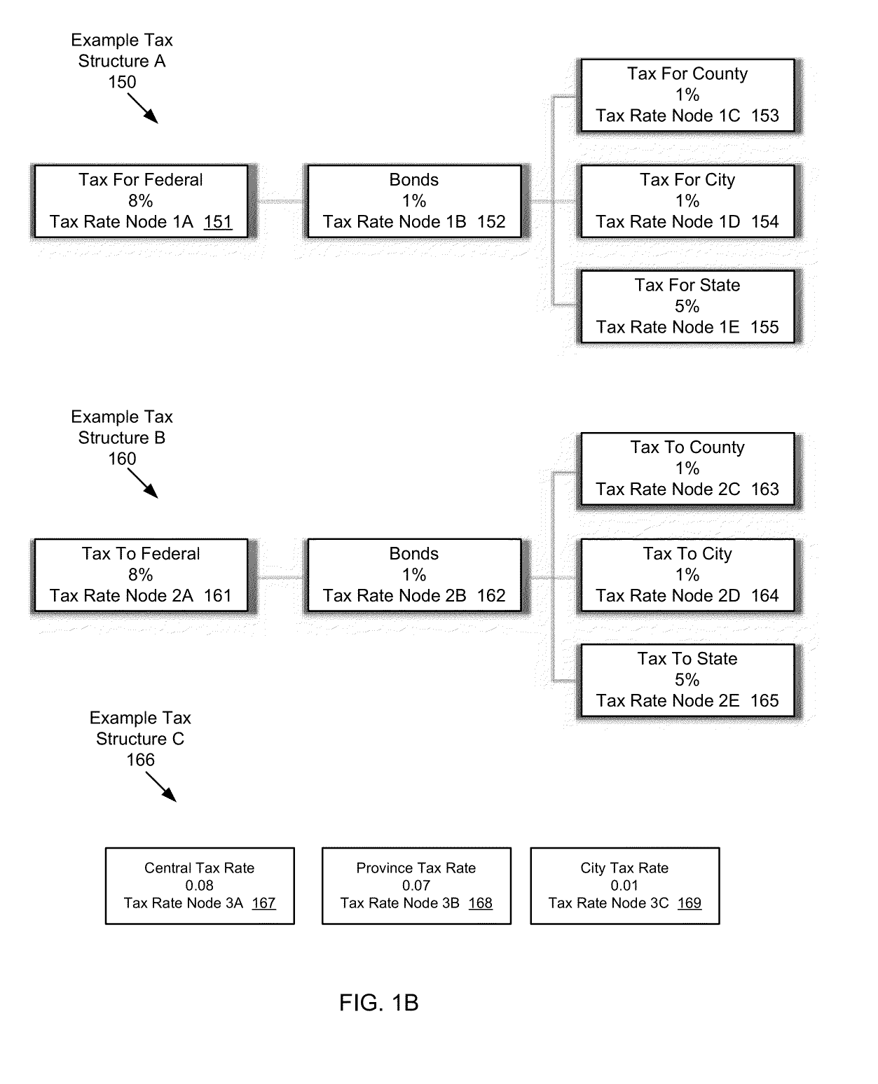

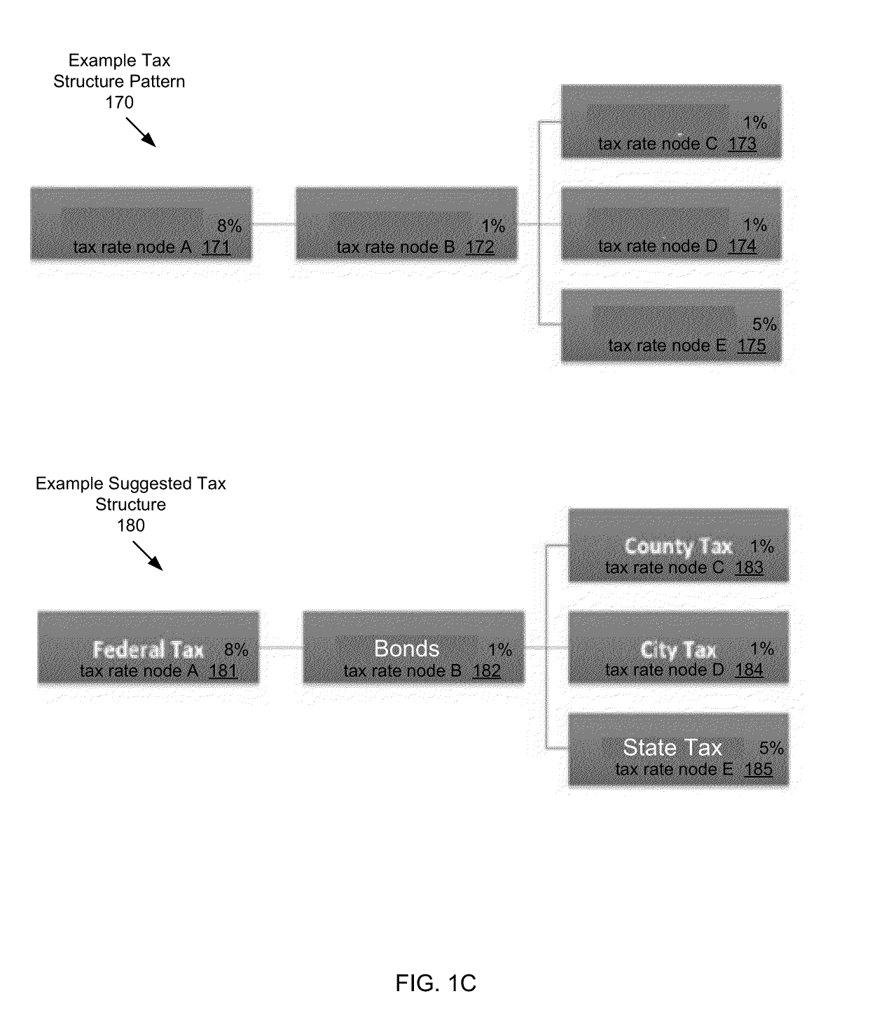

FIG. 1A depicts a schematic block diagram of a system (100) in accordance with one or more embodiments of the invention. In one or more embodiments of the invention, one or more of the modules and elements shown in FIG. 1A may be omitted, repeated, and/or substituted. Accordingly, embodiments of the invention should not be considered limited to the specific arrangements of modules shown in FIG. 1A.

As shown in FIG. 1A, the system (100) includes a computer server (105a) executing software application instantiations (e.g., software application instantiation A (105b), etc.) each includes a tax structure (e.g., tax structure A (105c)) storing a tax rate (e.g., tax rate A (105d)). The software application instantiations (e.g., software application instantiation A (105b), etc.) may be copies of an accounting software, a financial software, a web service, or any other online software product. The software application instantiation (105c) may also be a desktop application/product. In addition, each of the users (e.g., user A (101a), user N (101n), etc.) launches the software application to execute one of the software application instantiations (e.g., software application instantiation A (105b), etc.) using respective user devices (e.g., user device A (102a), user device N (102n), etc.). In one or more embodiments, the user devices (e.g., user device A (102a), user device N (102n), etc.) may be a desktop computer, notebook computer, tablet computer, or other suitable mobile computing devices such as a smartphone.

Although not specifically shown, the tax structure A (105c) may also include additional information, such as tax agency information, agency specific tax rate information, tax rate change information, etc. For example, the tax agency information may describe the agency to whom the tax is payable, tax registration number set up for the agency, frequency with which tax should be filed with the agency, whether the tax is calculated on a cash or accruals basis, whether the tax applies to items sold, items purchased, or both, and other applicable information regarding the agency, The agency specific tax rate information may include tax rates per agency based on which a group rate is established to charge multiple taxes for different tax agencies at the same time. The tax rate change information may describe whether, and if so how the tax rate changed over time (e.g., a tax rate was 8% in 2011, 5% in 2012, etc.) In one or more embodiments, the tax structure (e.g., tax structure A (105c)) may be a data file, a linked list, a data sequence, a database, a graphical representation, or any other suitable data structure stored in a repository (not shown) in the computer server (105a). Examples of the tax structure and tax rate are shown in FIG. 1B below.

In one or more embodiments, the software application instantiation A (105b) is a web based application such that the users (e.g., user A (101a), user N (101n), etc.) interacts with the software application instantiations (e.g., software application instantiation A (105b), etc.) using web browsers on respective user devices (e.g., user device A (102a), user device N (102n), etc.). In one or more embodiments, an instantiation of the software application (e.g., software application instantiation A (105b)) is downloaded onto a user device (e.g., user device A (102a)) where a user (e.g., user A (101a)) interacts with the downloaded instantiation of the software application via a UI menu displayed on the user device (e.g., user device A (102a)).

In one or more embodiments, each of the tax structures (e.g., tax structure A (105c)) is created and/or used by one or more users (e.g., user group (101)) to configure a corresponding instantiation of the software application (e.g., software application instantiation A (105b)) for performing a pre-determined task. For example, the pre-determined task may include generating a sales or purchase document (e.g., invoice, purchase order, sales order, receipt, payment request, etc.), preparing a tax agency filing (e.g., income tax filing, sales tax filing, etc.), preparing an accounting report (e.g, proposal, quotation, billing statement, payable report, expense report, etc.), etc. according to tax jurisdiction requirements of a particular geographical region. In particular, performing the pre-determined task within the geographical region may include at least calculating a tax amount based on the tax rate (e.g., tax rate A (105d)).

Some users (e.g., user A (101a),) may be members of a user group (e.g., user group (101). A user group may be, for example, a group of accountants working in the particular geographical region who jointly contribute to localization of the software application such that the resultant localized version of the software application is shared within the user group. Alternatively, in one or more embodiments of the invention, a user group or individual users may be tax experts wanting to configure tax structures and use such tax structures to advertise services in each geographic region. For example, the user A (101a) of a particular geographical region (e.g., a country) may have launched an execution of the software application instantiation A (105b) and created the tax structure A (105c) including the tax rate A (105d) according to regulatory requirements (e.g., tax jurisdiction requirements) of the particular geographical region. Accordingly, the tax structure A (105c) is included as an input contributing to a suggested tax structure (e.g., suggested tax structure (141)) for the particular geographical region. For example, the suggested tax structure may be presented to a new user (e.g., user N (101n) who may use the suggestion to generate an invoice, prepare an accounting report, preparing a tax agency filing, or performing another suitable pre-determined task within the particular geographical region.

FIG. 1B shows examples of tax structures, such as example tax structure A (150), example tax structure B (160), and example tax structure C (166) in accordance with one or more embodiments of the invention. In particular, these are examples of the tax structure A (105C) depicted in FIG. 1A above. In one or more embodiments of the invention, one or more of the modules and elements shown in FIG. 1B may be omitted, repeated, and/or substituted. Accordingly, embodiments of the invention should not be considered limited to the specific arrangements of modules shown in FIG. 1B.

As shown in FIG. 1B, the example tax structure A (150) includes a hierarchical graph of tax rate nodes each having a user defined tax label and a corresponding numerical tax rate. In one or more embodiments, the numerical tax rate is a percentage. In one or more embodiments, the numerical tax rate is a flat currency amount. Specifically, the tax rate node 1A (151) includes the user defined tax label “Tax For Federal” and the numerical tax rate “8%,” the tax rate node 1B (152) includes the user defined tax label “Bonds” and the numerical tax rate “1%,” the tax rate node 1C (153) includes the user defined tax label “Tax For County” and the numerical tax rate “1%,” the tax rate node 1D (154) includes the user defined tax label “Tax For City” and the numerical tax rate “1%,” and the tax rate node 1E (155) includes the user defined tax label “Tax For State” and the numerical tax rate “5%.”

In addition, the example tax structure B (160) includes a similar hierarchical graph of the tax rate node 2A (161) having the user defined tax label “Tax To Federal” and the numerical tax rate “8%,” the tax rate node 2B (162) having the user defined tax label “Bonds” and the numerical tax rate “1%,” the tax rate node 2C (163) having the user defined tax label “Tax To County” and the numerical tax rate “1%,” the tax rate node 2D (164) having the user defined tax label “Tax To City” and the numerical tax rate “1%,” and the tax rate node 2E (165) having the user defined tax label “Tax To State” and the numerical tax rate “5%.”

Further, the example tax structure C (166) includes tax rate node 3A (167) having the user defined tax label “Central Tax Rate” and the numerical tax rate “0.08,” tax rate node 3B (168) having the user defined tax label “Province Tax Rate” and the numerical tax rate “0.07,” and tax rate node 3C (169) having the user defined tax label “City Tax Rate” and the numerical tax rate “0.01.”

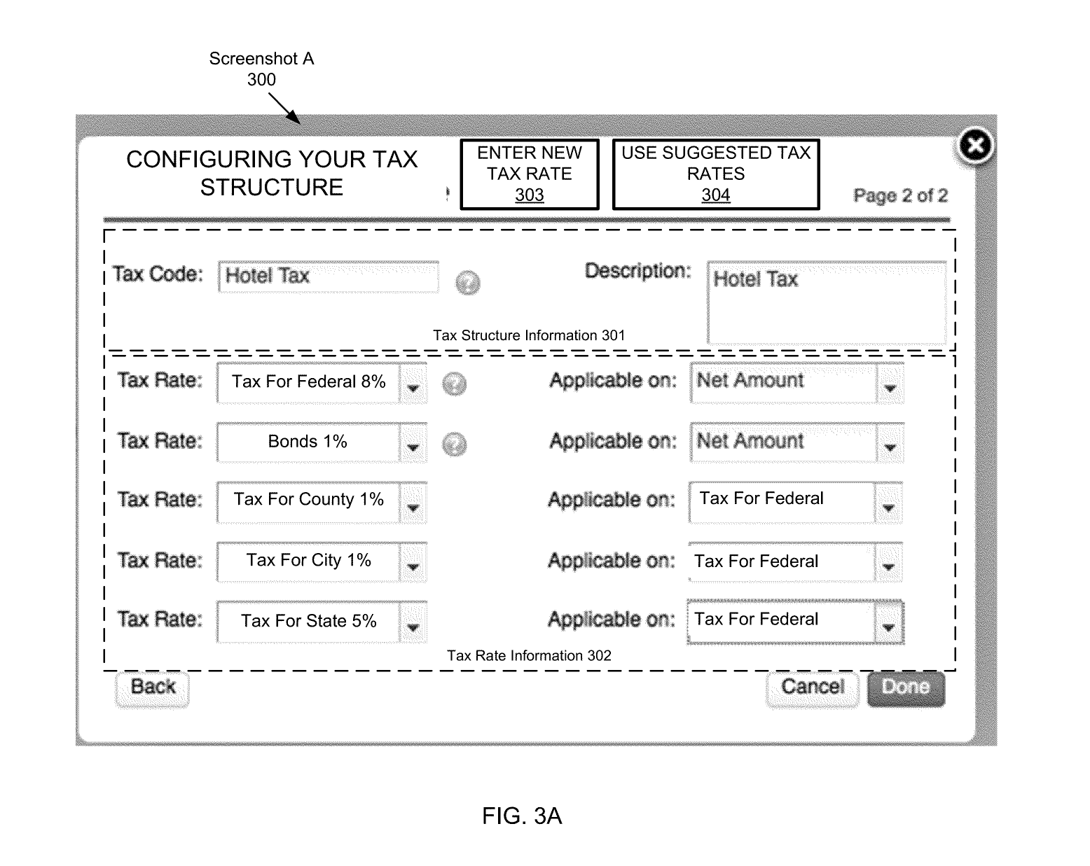

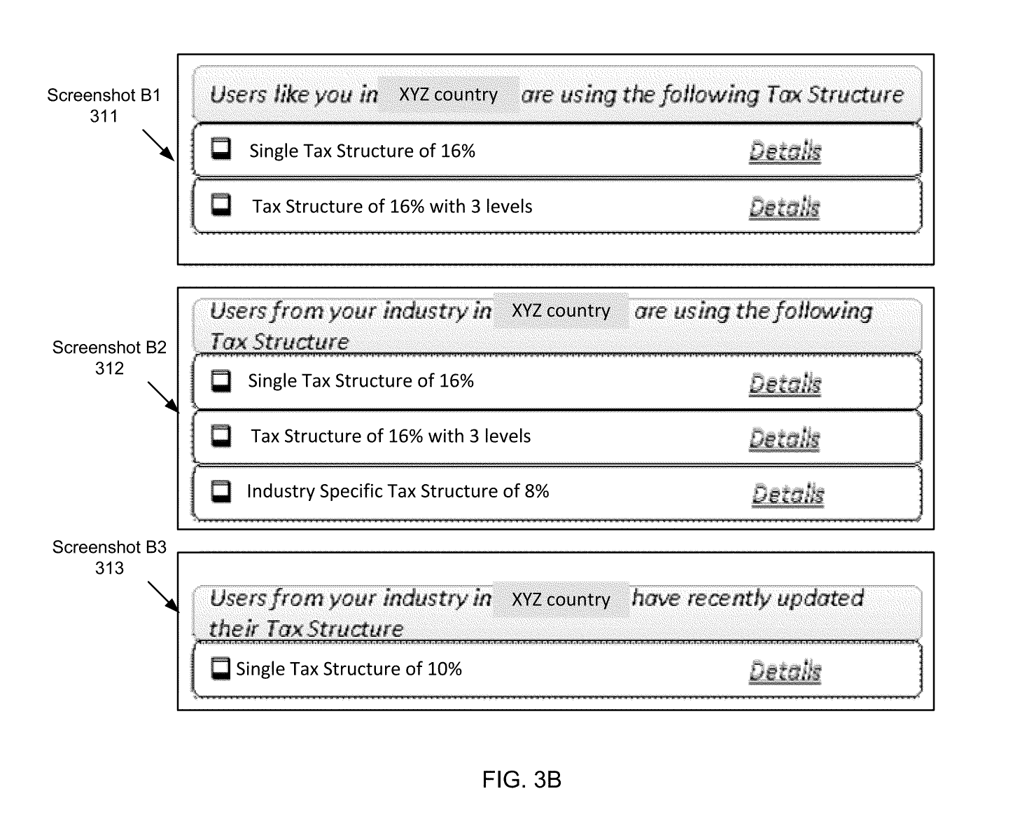

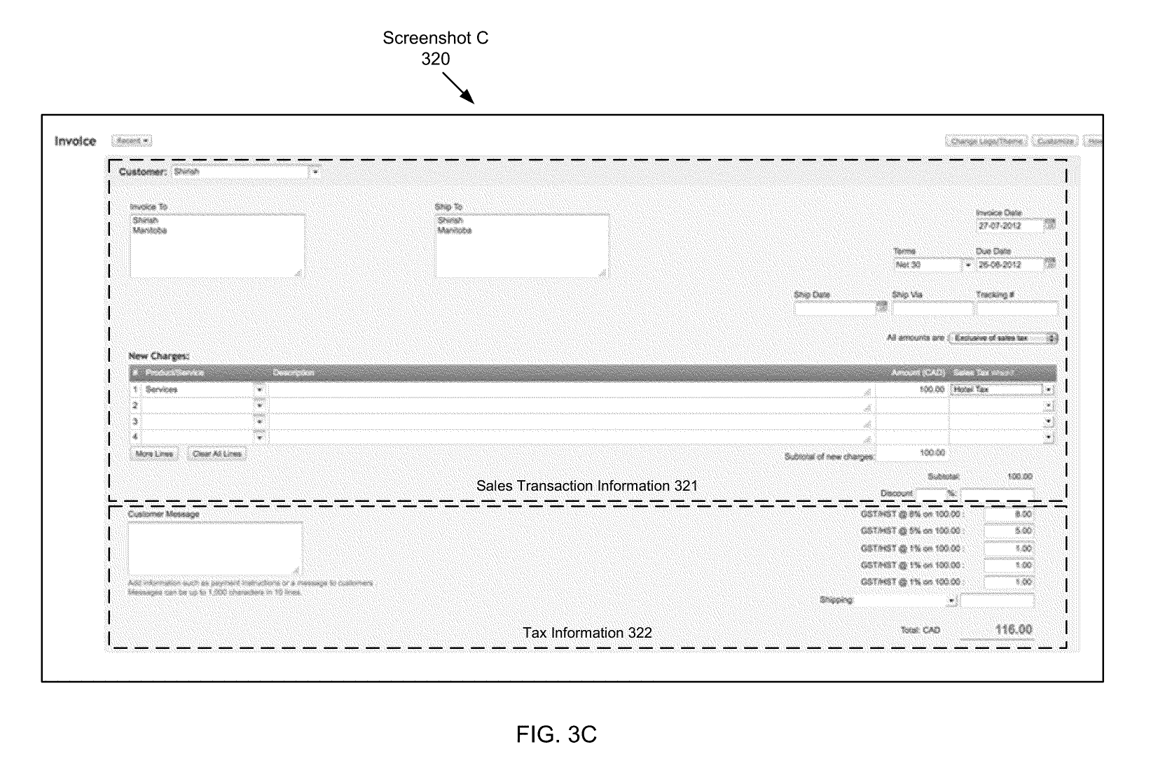

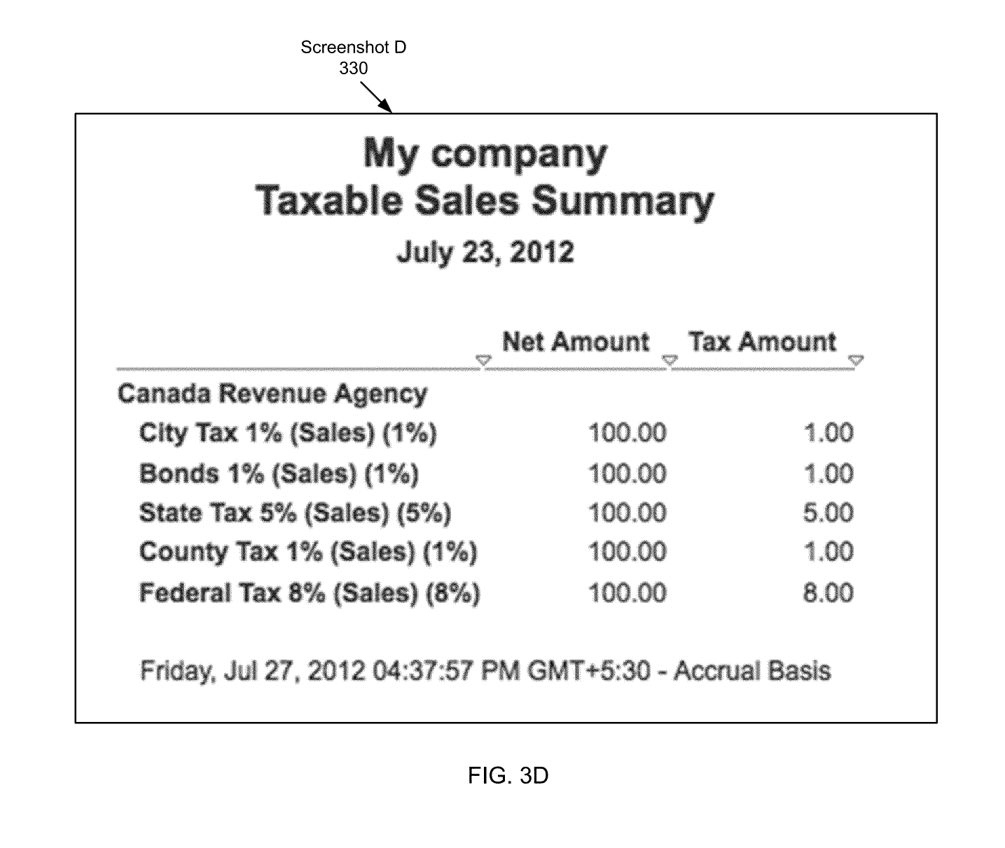

The example tax structure A (150) and the example tax structure B (160) are created by two users of an accounting software application for computing applicable taxes for various tax agencies (e.g., Federal tax agency, Municipal tax agency, County tax agency, City tax agency, State tax agency, etc.) accordingly to tax jurisdiction requirements of the particular geographical region (e.g., country) where the two users are located. Because the user has discretion in defining tax labels, the user defined tax labels from these two users who generated the graphical representations of the tax structures, although semantically consistent, have different wordings. Further, in one scenario, the tax structure C (166) may be created by a third user for a different transaction type or a different industry than the first two users in the same geographical region. In another scenario, the tax structure C (166) may be created by a third user who is in a different geographical region having a different tax jurisdiction requirement altogether. Further, as shown in FIG. 1B, the example tax structure A (150) and the example tax structure B (160) include hierarchical relationships among various tax rates, while the example tax structure C (166) does not include any relationship among tax rates. Said in other words, some tax structure may include only tax rates without specifying any relationships among them. Additional details of how these tax rates in a tax structure are used to compute tax amounts are described in reference to FIGS. 3A-3D below.

Returning to the discussion of FIG. 1A, the system (100) includes a tax structure localization tool (106) having a tax structure analyzer (107) and a repository (123) for storing intermediate data and resultant outputs of the tax structure analyzer (107). The repository (123) may include a disk drive storage device, a semiconductor storage device, other suitable computer data storage device, or combinations thereof. Various components of the system (100) are coupled via a computer network (110). For example, the computer network (110) may include wired and/or wireless portions of public and/or private data network, such as wide area networks (WANs), local area networks (LANs), Internet, etc.

In one or more embodiments of the invention, the tax structure analyzer (107) is configured to obtain a collection of tax structures (e.g., tax structure A (105c), etc.) generated by a group of users (e.g., user group (101)) according to a tax jurisdiction requirement of a geographical region. For example, the collection of tax structures (e.g., tax structure A (105c), etc.) may be retrieved from the computer server (105a) via an application programming interface (not shown) of each of the software application instantiations (e.g., software application instantiation A (105b), etc.). Once retrieved, the collection of tax structures (e.g., tax structure A (105c), etc.) or representative data/metadata thereof are stored in the repository (123) for use by the tax structure analyzer (107). In addition, usage statistics of the collection of tax structures (e.g., tax structure A (105c), etc.) for performing the pre-determined tasks by the group of users (e.g., user group (101)) are also retrieved from the computer server (105a) and stored in the repository (123). For example, a number of times the pre-determined task is performed using any one of the collection of tax structures (e.g., tax structure A (105c), etc.) by anyone of the group of users (e.g., user group (101)) may also be retrieved via the aforementioned application programming interface.

In one or more embodiments, the tax structure analyzer (107) is configured to generate a statistical measure (e.g., statistical measure A (140a), statistical measure M (140m), etc.) of the group of users (e.g., user group (101)) and/or a number of times the pre-determined task is performed by the group of users (e.g., user group (101)). In one or more embodiments, the tax structure analyzer (107) is further configured to generate, in response to the statistical measure (e.g., statistical measure A (140a), statistical measure M (140m), etc.) exceeding a pre-determined threshold (not shown), a suggested tax structure (e.g., suggested tax structure (141)) to represent a portion of the collection of tax structures (e.g., tax structure A (105c), etc.) that is qualified based on the statistical measure. In particular, the user group (101) and the qualified portion of the collection of tax structures generated thereby are considered statistically meaningful when the statistical measure exceeds the pre-determined threshold.

In one or more embodiments, the user device N (102n)) is configured to present the suggested tax structure (141) to the user N (101n), in response to at least determining that the user N (101n) is within the geographical region. Accordingly, the suggested tax structure (141) can be used by the user N (101n) to configure a respective instantiation of the software application for performing the pre-determined task within the geographical region. For example, the user N (101n) may be a new user of the software application who has not yet created, or otherwise configured the tax structure of the software application. In another example, the user N (101n) may have previously created a tax structure but decides to replace it by adopting the suggested tax structure (141).

In one or more embodiments, the tax structure analyzer (107) is configured to identify the user group (101), and therefore the collection of tax structures generated thereby as statistically meaningful based on one or more statistical measures. In one or more embodiments, any user group that is not determined as statistically meaningful is discarded by the tax structure analyzer (107). Said in other words, any suggested tax structure is generated only from a statistically meaningful user group, such as the user group (101). In addition, the user group (101) may be further qualified based on an industry designation in a user profile of each of the users (e.g., user A (101a)). Accordingly, the resultant suggested tax structure (e.g., suggested tax structure (141)) is specific to the particular industry.

In an example, the user group (101) may be identified based on a total tax rate that is same for each of the tax structures (e.g., tax structure A (105c)) used by users (e.g., user A (101a)) in the user group (101). In particular, the total tax rate is a sum of every tax rate (e.g., tax rate A (105d)) included in each of the tax structures (e.g., tax structure A (105c)). Said in other words, users using the same total tax rate in their tax structures are included in the user group (101). In this example, the statistical measure A (140a) may be a number of users in the user group (101) who have performed the pre-determined task based on the total tax rate. Said in other words, the statistical measure A (140a) is the size of the user group (101) using the same total tax rate. In addition, the statistical measure M (140m) may be a number of times the users in the user group (101) have performed the pre-determined task based on the same total tax rate. That is, the statistical measure M (140m) is a frequency measure of how often the same total tax rate is used by the user group (101). Accordingly, the suggested tax structure (141) may be generated when the size of the user group (101) and/or the frequency measure of using the same total tax rate by the user group (101) exceed a pre-determined threshold.

In yet another example, the user group (101) may be identified based on a tax structure pattern (e.g., tax structure pattern (140)) that is same for each of the tax structures (e.g., tax structure A (105c)) used by users in the user group (101). In particular, the tax structure pattern is a pattern of every tax rate included in a tax structure. Thus, a user group (101) may be defined by users whose tax structures share the same pattern. In this example, the statistical measure A (140a) may be a number of users in the user group (101) who have performed the pre-determined task based on the same tax structure pattern (140). In addition, the statistical measure M (140m) may be a number of times the users in the user group (101) have performed the pre-determined task based on the tax structure pattern (140). Said in other words, the statistical measure M (140m) is a frequency measure of how often the tax structure pattern (140) is used by the user group (101). Accordingly, the suggested tax structure (141) may be generated when the size of the user group (101) sharing the same tax structure pattern (140) and/or the frequency measure of using the same tax structure pattern (140) by the user group (101) exceed a pre-determined threshold.

In still another example, the user group (101) may be identified based on a combination of statistical measures, each exceeding a corresponding pre-determined threshold. In this example, the user group (101) is considered statistically meaningful if it has a number of registered users who have paid for the software application exceeding a first minimum user count, a number of users who have performed the pre-determined task based on the same total tax rate exceeding a second minimum user count, a number of users who have performed the pre-determined task based on the same tax structure pattern exceeding a third minimum user count, and a number of times that the users have performed the pre-determined task based on the same tax structure pattern exceeding a minimum number of times.

In one or more embodiments, the tax structure analyzer (107) is configured to analyze the collection of tax structures generated by the user group (101) to identify the tax structure pattern (140). Specifically, to identify the tax structure pattern (140) from the collection of tax structures, the tax structure analyzer (107) first determines that every tax structure in the collection has a same number of tax rates and a same total tax rate. In the example shown in FIG. 1B above, the example tax structure A (150) and the example tax structure B (160) are determined to have the same number (i.e., five) of tax rates and the same total tax rate (i.e., 16%, which is the sum of 8%+1%+1%+1%+5%). Accordingly, the example tax structure A (150) and the example tax structure B (160) are both included in the collection of tax structures that are analyzed to identify a common pattern.

In response to the determining that every tax structure in the collection has a same number of tax rates and/or a same total tax rate, the tax structure analyzer (107) analyzes the user defined tax label for every tax rate in the collection of tax structures that has a same percentage value to identify a plurality of tax categories. As described in the example shown in FIG. 1B above, each tax rate in a particular tax structure in the collection is identified by a user defined tax label specific to the particular tax structure. In this example, the user defined tax labels “Tax For Federal” and “Tax to Federal” associated with the same 8% tax rate are analyzed to identify a tax category that is assigned the system defined tax label “Federal Tax.” Further, the user defined tax labels “Bonds,” “Tax For County,” “Tax To County,” “Tax For City,” and “Tax to City” that are associated with the same 1% tax rate are analyzed to identify three tax categories that are assigned the system defined tax label “Bonds,” “County Tax,” and “City Tax,” respectively. In particular, each of the tax categories represents those user defined tax labels that are semantically equivalent with respect to the tax jurisdiction requirement of the geographical region and identify a same one of the tax rates.

For example, the tax category “County Tax” identifies the 1% tax rate and represents the user defined tax labels “Tax For County” and “Tax To County” that are semantically equivalent to each other with respect to the county tax requirement where the two users are in. Thus, although the two semantically equivalent user defined tax labels “Tax For County” and “Tax To County” are each specific to the corresponding one of the example tax structure A (150) and the example tax structure B (160), they both refer to the same 1% tax rate for the County tax jurisdiction within the geographical region. In one or more embodiments, the user defined tax labels “Tax For County” and “Tax To County” are analyzed to generate the system defined tax label “County Tax” using semantic analysis techniques known to those skilled in the art. Such semantic analysis techniques may include, but are not limited to, word cloud analysis technique, cluster analysis technique, latent semantic analysis/indexing, Latent Dirichlet allocation, etc.

In some tax jurisdictions in certain geographical regions, different tax structures may be applicable to different types of transactions or different types of industry. For example, a purchase of food products, a purchase of non-food products, and a purchase of services may be considered three different transaction types and incur different tax rates from different tax agencies. Further, different tax rates from different tax agencies may be applied to purchases in the energy industry versus the fast food industry. In one or more embodiments, multiple suggested tax structures may be generated by the tax structure analyzer (107) as contributed by users regulated by a single tax jurisdiction of a single geographical region that are involved with different types of transactions or different types of industry. Thus, suggested tax structures may be industry-specific or may somehow concatenate different tax structure patterns based on different industries or transaction types.

For example, the suggested tax structure (141) may be applicable to the transaction type for food product or applicable to the energy industry. In this example, the tax structure analyzer (107) is further configured to generate other suggested tax structures (not shown) applicable to the transaction types for service purchases and non-food product purchases or applicable to other industries, such as fast food industry. In particular, these other suggested tax structures are generated based on different tax structure patterns (not shown) than the tax structure pattern (140). In one or more embodiments, these different tax structure patterns (not shown) are derived from the same statistical measure(s) and pre-determined thresholds than those used to derive the tax structure pattern (140). In one or more embodiments, these different tax structure patterns (not shown) are derived from different statistical measure(s) and/or different pre-determined thresholds than those used to derive the tax structure pattern (140).

For example, the example tax structure pattern (170) and the example suggested tax structure (180) shown in FIG. 1C are generated from the example tax structure A (150) and the example tax structure B (160) shown in FIG. 1B and may represent the tax rates for transaction type of non-food product purchases. Accordingly, the example suggested tax structure (180) may be presented to a new user (e.g., user N (101n)) when the new user is identified as a merchant involved in non-food product purchases. In this example, the tax structure C (166) shown in FIG. 1B may be created for the transaction type of food product purchases or service purchases.

In another example, the example tax structure pattern (170) and the example suggested tax structure (180) shown in FIG. 1C are generated from the example tax structure A (150) and the example tax structure B (160) shown in FIG. 1B and may represent the tax rates applicable to the energy industry. Accordingly, the example suggested tax structure (180) may be presented to a new user (e.g., user N (101n)) when the new user is identified as a merchant in the energy industry. In this example, the tax structure C (166) shown in FIG. 1B may be created for the fast food industry.

Generally, the suggested tax structure (141) is applicable to a particular tax jurisdiction of a particular geographical region. In one or more embodiments, multiple suggested tax structures may be generated by the tax structure analyzer (107) as contributed by users regulated by different tax jurisdictions in different geographical regions. For example, the tax structure analyzer (107) is further configured to generate other suggested tax structures (not shown) applicable to other tax jurisdictions in different geographical regions than the suggested tax structure (141). In particular, these other suggested tax structures are generated based on different tax structure patterns (not shown) than the tax structure pattern (140). In one or more embodiments, these different tax structure patterns (not shown) are derived from the same statistical measure(s) and pre-determined thresholds than those used to derive the tax structure pattern (140). In one or more embodiments, these different tax structure patterns (not shown) are derived from different statistical measure(s) and/or different pre-determined thresholds than those used to derive the tax structure pattern (140).

For example, the example tax structure pattern (170) and the example suggested tax structure (180) shown in FIG. 1C are generated from the example tax structure A (150) and the example tax structure B (160) shown in FIG. 1B and may represent the tax rates specified by a particular tax jurisdiction of a particular geographical region. Accordingly, the example suggested tax structure (180) may be presented to a new user (e.g., user N (101n)) when the new user is identified as a merchant regulated by this particular tax jurisdiction (e.g., the new user is located in the same particular geographical region). In this example, the tax structure C (166) shown in FIG. 1B may be created for a different tax jurisdiction specifying different tax rates in a different geographical region.

In one or more embodiments, when a new user (e.g., user N (101n)) is configuring a new instantiation of the software application, a user interface window is presented requesting the new user to select between manually creating a new tax structure or using a tax structure suggestion function of the software application. If the option of manually creating the new tax structure is selected, the user interface would request further input from the new user (e.g., user N (101n)) to generate the new tax structure. An example user interface window for requesting user input to generate the new tax structure is shown in FIG. 3A below. If the option of using the tax structure suggestion is selected, the example suggested tax structure (180) may then be presented to the new user (e.g., user N (101n)) to be adopted. Similarly, the tax structure A (105c) configured in the software application instantiation A (105b) may have been previously created by the user A (101a) selecting the manual option or adopted by the user A (101a) selecting the tax structure suggestion function of the software application.

FIG. 1C shows the example tax structure pattern (170) and the example suggested tax structure (180) in accordance with one or more embodiments of the invention. In particular, these are examples of the tax structure pattern (140) and the suggested tax structure (141) depicted in FIG. 1A above. In one or more embodiments of the invention, one or more of the modules and elements shown in FIG. 1C may be omitted, repeated, and/or substituted. Accordingly, embodiments of the invention should not be considered limited to the specific arrangements of modules shown in FIG. 1C.

As shown in FIG. 1C, the example tax structure pattern (170) includes a hierarchical graph of tax rate nodes each having a numerical tax rate. Specifically, the tax rate node A (171) includes the numerical tax rate “8%,” the tax rate node B (172) includes the numerical tax rate “1%,” the tax rate node C (173) includes the numerical tax rate “1%,” the tax rate node D (174) includes the numerical tax rate “1%,” and the tax rate node E (175) includes the numerical tax rate “5%.” In particular, these tax rates are the same as corresponding ones in both the example tax structure A (150) and the example tax structure B (160) depicted in FIG. 1B above. Thus, the hierarchical graph depicted in FIG. 1C is the common pattern observed in both hierarchical graphs of the example tax structure A (150) and the example tax structure B (160) depicted in FIG. 1B above. In one or more embodiments, the common pattern is automatically identified by analyzing the numerical tax rates and semantic meanings of the corresponding user defined tax labels in each hierarchical level separately in the tax structures. In one or more embodiments, the common pattern is automatically identified by analyzing the numerical tax rates and semantic meanings of the corresponding user defined tax labels regardless of any hierarchical level in the tax structures. Although the example tax structure pattern (170) includes hierarchical relationships among various tax rates, other example tax structure pattern may not include any relationship among tax rates. Said in other words, some tax structure pattern may include only tax rates without specifying any relationships among them. For example, any pattern that may be derived from example tax structure C (166) may not include any relationship among tax rates.

Further as shown in FIG. 1C, the example suggested tax structure (180) is essentially the same as the example tax structure pattern (170) with the exception that each of the numerical tax rates is assigned a system defined tax label. Specifically, the tax rate node A (181) includes the numerical tax rate “8%” assigned a system defined tax label “Federal Tax,” the tax rate node B (182) includes the numerical tax rate “1%” assigned a system defined tax label “Bonds,” the tax rate node C (183) includes the numerical tax rate “1%” assigned a system defined tax label “County Tax,” the tax rate node D (184) includes the numerical tax rate “1%” assigned a system defined tax label “City Tax,” and the tax rate node E (185) includes the numerical tax rate “5%” assigned a system defined tax label “State Tax.” In particular, the system defined tax label “Federal Tax” are automatically generated by analyzing corresponding user defined tax labels “Tax For Federal” and “Tax to Federal” found in the tax rate node 1A (151) and the tax rate node 2A (161), respectively. Similarly, the other system defined tax labels “Bonds,” “County Tax,” “City Tax,” and “State Tax” are automatically generated by analyzing corresponding user defined tax labels found in the tax rate node 1A (151) and the tax rate node 2A (161) depicted in FIG. 1B. In one or more embodiments, the system defined tax labels are automatically generated by analyzing user defined tax labels in each hierarchical level separately in the tax structures. In one or more embodiments, the system defined tax labels are automatically generated by analyzing user defined tax labels regardless of any hierarchical level in the tax structures. Although the example suggested tax structure (180) includes hierarchical relationships among various tax rates, other example suggested tax structure may not include any relationship among tax rates. Said in other words, some suggested tax structure may include only tax rates assigned with system defined tax labels without specifying any relationships among the tax rates.

In one or more embodiments, the tax structure pattern (e.g., example tax structure pattern (170)) and the suggested tax structure (e.g., example suggested tax structure (180)) may be stored as a data file, a linked list, a data sequence, a database, a graphical representation, or any other suitable data structure in the repository (123), as shown in FIG. 1A.

Although the example tax structures shown in FIGS. 1B and 1C are based on income taxes, the tax structures may also include sales taxes or any other type of taxes. In additional to the name of the tax, each tax in the example tax structures shown in FIGS. 1B and 1C may also be tagged with additional information, such as name of collecting agency, type of tax, effective date(s) of tax rate, method of calculating tax, applicable tax return form, goods and/or services that tax rate is applicable to, income and/or expenses that tax rate is applicable to, etc. Further, the example tax structures may also include grouped tax rates, which are combinations of tax rates from different taxes. In particular, a grouped tax rate may be used to charge multiple taxes (e.g., levied over goods, service, income, expense, or any other taxable item) during a single transaction.

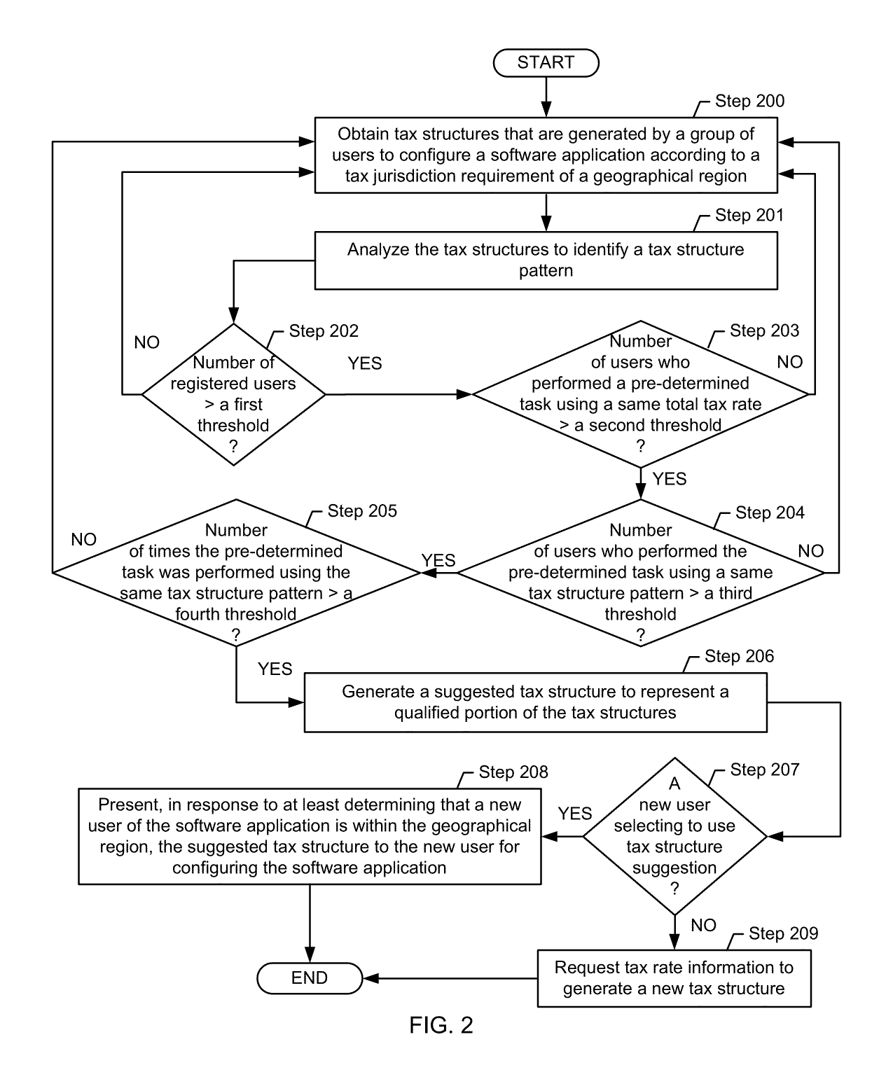

FIG. 2 depicts a flowchart of a method in accordance with one or more embodiments of the invention. In one or more embodiments of the invention, one or more of the steps shown in FIG. 2 may be omitted, repeated, and/or performed in a different order. Accordingly, embodiments of the invention should not be considered limited to the specific arrangements of steps shown in FIG. 2. In one or more embodiments, the method described in reference to FIG. 2 may be practiced using the system (100) described in reference to FIG. 1A above.

Initially in Step 200, tax structures of a software application are obtained from a group of users. For example, the software application may be an accounting software, a financial software, a web service, or any other online software product while the tax structures may be those described in reference to FIGS. 1A and 1B above. In particular, the software application is used by the group of users to perform a pre-determined task, such as generating an invoice, an accounting report, or a tax agency filing. In one or more embodiments, the tax structures are generated by the group of users according to a tax jurisdiction requirement of a geographical region. Specifically, each of the tax structures includes one or more tax rates and is used by a user of the group to configure an instantiation of the software application for performing the pre-determined task in compliance with the tax jurisdiction requirement. For example, generating the invoice, accounting report, or tax agency filing includes calculating a tax amount based on a tax rate of the tax structures that is dictated by the tax jurisdiction.

In one or more embodiments, the group of users is identified based on a total tax rate that is same for each of the tax structures, where the total tax rate is a sum of every tax rate included in the each of the tax structures. In one or more embodiments, the group of users is identified based on a same number of tax rates in each of the tax structures, where each tax rate in a particular tax structure is identified by a user defined tax label specific to that particular tax structure. In one or more embodiments, the group of users is identified based on a tax structure pattern that is same for each of the tax structures, where the tax structure pattern includes every tax rate included in each of the tax structures. In one or more embodiments, the group of users is identified based on an industry designation in a user profile of each user. Said in other words, the group of users is identified such that their tax structures all have a same total tax rate, a same number of tax rates, and/or a same tax rate pattern. Further, the group of users may be qualified based on their industry association.

In Step 201, the tax structures are analyzed to identify a tax structure pattern. For example, the tax structure pattern may be among those described in reference to FIGS. 1A to 1C above. In one or more embodiments, it is first determined that every tax structure includes a same number of tax rates and a same total tax rate. As noted above, the total tax rate is a sum of every tax rate in any one of the tax structures, where each tax rate in a particular tax structure is identified by a user defined tax label specific to that particular tax structure.

Because the user defined tax labels are defined based on user discretion, the user defined tax labels from different users, although semantically consistent, may have different wordings. After determining that every tax structure includes a same number of tax rates and a same total tax rate, the user defined tax labels tagging on tax rates of the same percentage value are analyzed to identify their semantic meaning(s). Generally, the tax rates in these tax structures can be categorized based on different semantic meanings of the user defined tax labels.

In one or more embodiments, the user defined tax labels for every tax rate in these tax structures that have a same percentage value are analyzed to identify one or more tax categories. In particular, each tax category represents those user defined tax labels that are semantically equivalent with respect to the tax jurisdiction requirement of the geographical region. Accordingly, each tax category identifies a single tax rate specified by the tax jurisdiction requirement. In one or more embodiments, the tax rates for all identified tax categories form a tax structure pattern. For example, the tax structure pattern may include a sequence of tax rates each associated with one of the identified tax categories. In another example, the tax structure pattern may include tax rates associated with the identified tax categories without any sequencing or hierarchical information.

In one or more embodiments, those tax structures sharing the same tax structure pattern but having different wordings in their particular user defined tax labels are considered as equivalent tax structures. In one or more embodiments, equivalent tax structures are represented by a single representative tax structure that includes the common tax structure pattern where the tax rate of each tax category in the common tax structure pattern is assigned a system defined tax label. For example, the system defined tax label may be defined based on the equivalent semantic meaning of the user defined tax labels and represent a respective tax dictated by the tax jurisdiction requirement of the geographical region. In one or more embodiments, a representative tax structure is provided to a new user as a suggested tax structure based on certain pre-determined statistical measures described in Steps 202 through 205 below. In particular, these statistical measures relate to the group of users (referred to as the user group) and a number of times the pre-determined task is performed by the group of users.

In Step 202, a determination is made as to whether the number of registered users who have paid for the software application in the user group exceeds a first threshold. In one or more embodiments, the registered users also include those who received a free copy of the software application under a pre-determined license agreement. If the answer is no, the method returns to Step 200 to collect additional tax structures from addition users. If the answer is yes, the method proceeds to Step 203. In one or more embodiments, the number of users in the user group regardless of their registration status may be used as the criterion.

In Step 203, a determination is made as to whether the number of users in the user group who have performed the pre-determined task based on the same total tax rate exceeds a second threshold. If the answer is no, the method returns to Step 200 to collect additional tax structures from addition users. If the answer is yes, the method proceeds to Step 204. In one or more embodiments, users may be weighted differently based on user attributes in counting the number of users. The user attributes may include professional designation of the user, geographical location of the user, tax jurisdiction of the user, job title of the user, industry of the user, goods/services provided or purchased by the user, income and/or expenses recorded or claimed by the user, assets and liabilities of the user, tax status of the user (e.g., self-reported tax status, registrations with tax agencies, exemptions from tax agencies, etc.), tax return filing count and/or frequency of the user, type of tax-related activities performed by the user in the software, length of time the user has been using the software application, number of times the user has logged into the software application, how long the user has been renewing the license of the software application, etc. For example, an accountant may be counted as 1.5 users such that tax structures from accountants may be emphasized (i.e., assigned more weight) than those from ordinary users.

In Step 204, a determination is made as to whether the number of users in the user group who have performed the pre-determined task based on the same tax structure pattern exceeds a third threshold. If the answer is no, the method returns to Step 200 to collect additional tax structures from addition users. If the answer is yes, the method proceeds to Step 205.

In Step 205, a determination is made as to whether the number of times that the pre-determined task has been performed by the user group based on the same tax structure pattern exceeds a fourth threshold. If the answer is no, the method returns to Step 200 to collect additional tax structures from addition users. If the answer is yes, the method proceeds to Step 206.

In Step 206, a suggested tax structure is generated to represent a qualified portion of the tax structures. Specifically, the qualified portion of the tax structures includes those tax structures that meet the criterion of the Steps 202 through 205. Said in other words, the aforementioned representative tax structure is qualified as the suggested tax structure when all criterions in these Steps are met.

In Step 207, a determination is made as to whether a new user has selected to use tax structure suggestion or not. In particular, the user selection is received when the new user is configuring the software application, for example to generate an invoice, an accounting report, a tax agency filing, etc. If the answer is no, the method proceeds to Step 209, where a user interface window is presented to the new user requesting tax rate information for generating a new tax structure. If the answer is yes, the method proceeds to Step 208 where the suggested tax structure is presented to the new user in response to at least determining that the new user is configuring the software application within the geographical region of the suggested tax structure. In this manner, the new user can generate the invoice, accounting report, tax agency filing, etc. in compliance to the tax jurisdiction of the geographical region.

As described above, the Steps 200 through 208 may be performed separately for user groups involved with different transaction types, performed separately for user groups in different industries, and performed separately for user groups in different geographical regions regulated by different tax jurisdictions. Accordingly, the process of FIG. 2 may be repeated based on one or more distinctions as described above.

FIGS. 3A-3D show an application example in accordance with one or more embodiments of the invention. This application example may be practiced using the system (100) of FIG. 1A and based on the method described with respect to FIG. 2 above.

FIG. 3A shows a screenshot A (300) of a user interface menu in an accounting software. Specifically, the user interface menu allows the new user to configure the tax structure before performing any tax related tasks using the accounting software. In the scenario shown in the screenshot A (300), the new user has selected to create a new tax structure by activating the command button (303) “ENTER NEW TAX RATE.” In response, the bottom panel is displayed requesting the user to enter tax rate information (302). As shown, the new user has specified that the entered tax rate information pertains to hotel tax and includes five different tax rates. Specifically, these five tax rates correspond to the example tax structure A (150) shown in FIG. 1B above. In this example, the first two tax rates are based on net amount of the invoice transaction while the bottom three tax rates are based on the amount of tax for Federal, which is computed based on the first tax rate “Tax For Federal 8%.” These dependencies are captured in the example tax structure A (150) based at least on the hierarchical structure therein. In other example where all tax rates are uniformly based on net transaction amount, the tax structure may be flat without any hierarchical structure.

In a different scenario, the new user may select to adopt a system suggested tax structure by activating the command button (304) “USE SUGGESTED TAX RATES.” In response, the new user is presented with a selection menu shown in FIG. 3B instead of the bottom panel requesting tax rate information (302).

In yet another scenario, the new user may search for a system suggested tax structure from other user interface menu of the software application. In response, the new user is presented with a selection menu shown in FIG. 3B to adopt a selected suggestion.

In still another scenario, the new user may have received a social network posting from a social network friend (e.g., another accountant user) that includes an embedded link regarding a system suggested tax structure. In particular, the embedded link includes the URL of a login page for the accounting software application and is concatenated with a reference to the particular system suggested tax structure. For example, this social network friend may be performing an accounting task using an instantiation of the accounting software and click a “share via social network” command button included in a user interface menu of the accounting software instantiation. Clicking the “share via social network” command button causes the social network posting to be presented to the new user. When viewing this social network posting, the new user may click on the embedded link and get re-directed to the login page for the accounting software application. Once logged-in, the new user is presented with a selection menu shown in FIG. 3B to adopt a selected suggestion. In particular, the system suggested tax structure recommended by the social network friend is identified by the accounting software application from a community database based on the concatenated reference to the login page URL.

Generally, any user can create and/or adopt as many tax structures as necessary. For example, a hotel owner in Canada may specify three taxes: the federally-mandated GST (Goods and Services Tax in Canada that is similar to Federal Sales Tax in the U.S.), the provincially-mandated PST (Provincial Sales Tax in Canada that is similar State Sales Tax in the U.S.), and the provincially-mandated Hotel Tax. All three of these taxes are applicable to this user's sales of hotel rooms. However, only GST and HST need to be applied to sales of other items, such as meals or sundries. Therefore, the hotel owner user may create and/or adopt two separate tax structures.

FIG. 3B shows a screenshot B1 (311) of the selection menu where the new user may select one of two suggested tax structures that are suggested based on the new user's tax jurisdiction. The two selections may be applicable to different types of the transaction that the user may process. FIG. 3B also shows a screenshot B2 (312) of another selection menu where the new user may select one of three suggested tax structures that are suggested based on the new user's tax jurisdiction. Two of the selections may be applicable to different types of the transaction that the user may process while the third selection allows the new user to use a tax structure customized for a specific industry. Although not specifically shown in FIG. 3B, the suggested tax structures may be suggested based on various attributes of the new user or activities performed (or to be performed) by the new user in the software application. The user attributes may include, but not limited to professional designation of the user, geographical location of the user, tax jurisdiction of the user, job title of the user, industry of the user, goods/services provided or purchased by the user, income and/or expenses recorded or claimed by the user, assets and liabilities of the user, tax status of the user (e.g., self-reported tax status, registrations with tax agencies, exemptions from tax agencies, etc.), tax return filing count and/or frequency of the user, type of tax-related activities performed by the user in the software, length of time the user has been using the software application, number of times the user has logged into the software application, how long the user has been renewing the license of the software application, etc. The activities performed (or to be performed) by the new user in the software application may include, but not limited to pre-sales and sales activities (e.g., creating or recording a particular type of estimates, proposals, quotations, sales orders, invoices, receipts, statements, and/or other requests for payment), income activities (e.g., recording or itemizing a particular type of income and its sources), pre-purchase and purchase activities (e.g., creating or recording a particular type of purchase orders, bills, expenses, cheques, credit card, debit card, and/or other requests for and methods of payment), expense activities (e.g., recording or itemizing a particular type of expenses and their sources), and other activities, such as preparing a particular type of accounting report, preparing or reviewing a particular type of tax agency filing, etc.

In other words, the suggested tax structures may be based on tax structures used by other users sharing one or more of these attributes with the new user. Further, the suggested tax structures may be based on tax structures used by other users who have also performed one or more of these activities using the software application, as has been or will be performed by the new user.

After the new user has adopted one of the suggested tax structures, the new user may receive a notification alert that the adopted tax structure may have been recently updated by other users in the same tax jurisdiction. The screenshot B3 (313) shows an example of such notification where the user may adopt the updated tax structure by clicking on the line item in the notification to replace the previously adopted version. In each of the screenshot B1 (311), screenshot B2 (312), and screenshot B3 (313), the new user may view the tax structure by clicking on the command button labeled “Details.” Accordingly, a graphical representation or other details such as the example tax structure A (150) shown in FIG. 1B may be presented to the new user. For example, other details may include data entry fields and command buttons allowing the new user to provide feedback and rate the system suggested tax structures.

FIG. 3C shows a screenshot C (320) of a predetermined task generation menu of the accounting software application. As shown, in the example of FIG. 3C, the new user is generating an invoice after adopting the suggested tax structure or creating a new tax structure. The invoice generation menu includes a top panel where the new user enters sales transaction information (321) and a bottom panel displaying the tax information (322) computed by the accounting software application based on the tax structure adopted or created by the new user. Those skilled in the art will appreciate that the software application instantiation being used by the new user may perform other predetermined tasks, such as generation of other types of documents or reports, preparing tax filings, etc.

FIG. 3D shows a screenshot D (330) of a report menu of the accounting software application. As shown, the new user is preparing an accounting report after adopting the suggested tax structure or creating a new tax structure. The report menu displays the accounting report detailing tax amounts computed based on the tax rates of the tax structure adopted or created by the new user.

Although the example described in reference to the FIGS. 3A-3D above refers to the scenario when the new user is configuring the tax structure of the accounting software application, the example may also apply to a different scenario when an existing user is re-configuring the tax structure by either re-entering new tax rate information or adopting a suggested tax structure to replace the existing tax structure of the accounting software application.

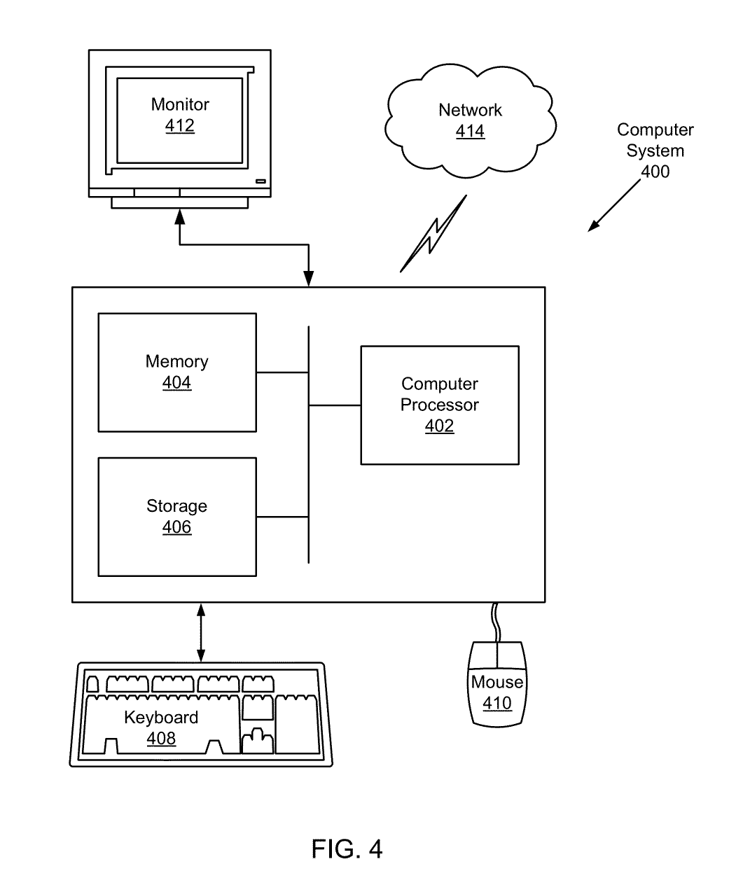

Embodiments of the invention may be implemented on virtually any type of computer regardless of the platform being used. For example, as shown in FIG. 4, a computer system (400) includes one or more computer processor(s) (402) such as a central processing unit (CPU), integrated circuit, or other hardware processor, associated memory (404) (e.g., random access memory (RAM), cache memory, flash memory, etc.), a storage device (406) (e.g., a hard disk, an optical drive such as a compact disk drive or digital video disk (DVD) drive, a flash memory stick, etc.), and numerous other elements and functionalities typical of today's computers (not shown). The computer system (400) may also include input means, such as a keyboard (408), a mouse (410), or a microphone (not shown). Further, the computer system (400) may include output means, such as a monitor ((412) (e.g., a liquid crystal display (LCD), a plasma display, or cathode ray tube (CRT) monitor). The computer system (400) may be connected to a network (414) (e.g., a local area network (LAN), a wide area network (WAN) such as the Internet, or any other similar type of network)) with wired and/or wireless segments via a network interface connection (414). Those skilled in the art will appreciate that many different types of computer systems exist, and the aforementioned input and output means may take other forms. Generally speaking, the computer system (400) includes at least the minimal processing, input, and/or output means necessary to practice embodiments of the invention.

Further, those skilled in the art will appreciate that one or more elements of the aforementioned computer system (400) may be located at a remote location and connected to the other elements over a network. Further, embodiments of the invention may be implemented on a distributed system having a plurality of nodes, where each portion of the invention may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions for performing embodiments of the invention may be stored on a non-transitory computer readable storage medium such as a compact disc (CD), a diskette, a tape, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method to generate a suggested tax structure in a software application for a geographical region, comprising:
obtaining a plurality of tax structures generated by a plurality of users according to a tax jurisdiction requirement of the geographical region,
wherein each of the plurality of tax structures comprises a tax rate that is used by the plurality of users to configure a plurality of instantiations of the software application for performing a pre-determined task, and
wherein performing the pre-determined task within the geographical region comprises at least calculating a tax amount based on the tax rate;
generating, by a computer processor, a statistical measure of the plurality of users and a number of times the pre-determined task is performed by the plurality of users;
generating, by the computer processor and in response to the statistical measure exceeding a pre-determined threshold, a suggested tax structure to represent a portion of the plurality of tax structures that is qualified based on the statistical measure; and
presenting, in response to at least determining that a new user of the software application is within the geographical region, the suggested tax structure to the new user, wherein the suggested tax structure is used by the new user to configure a new instantiation of the software application for performing the pre-determined task within the geographical region.

2. The method of claim 1, further comprising:
identifying the plurality of users based on an industry designation in a user profile of each of the plurality of users.

3. The method of claim 1, wherein performing the pre-determined task within the geographical region further comprises generating, based on the tax amount, at least one selected from a group consisting of an invoice, a purchase order, an accounting report, and a tax agency filing.

4. The method of claim 1, wherein the statistical measure comprises a number of registered users who have paid for the software application.

5. The method of claim 1, further comprising:
identifying the plurality of users based on a total tax rate that is same for each of the plurality of tax structures,
wherein the total tax rate comprises a sum of every tax rate included in each of the plurality of tax structures, and
wherein the statistical measure comprises a number of users among the plurality of users who have performed the pre-determined task based on the total tax rate.

6. The method of claim 1, further comprising:
identifying the plurality of users based on a total tax rate that is same for each of the plurality of tax structures,
wherein the total tax rate comprises a sum of every tax rate included in the each of the plurality of tax structures, and
wherein the statistical measure comprises a number of times that the plurality of users have performed the pre-determined task based on the total tax rate.

7. The method of claim 1, further comprising:
identifying the plurality of users based on a tax structure pattern that is same for each of the plurality of tax structures,
wherein the tax structure pattern comprises every tax rate included in each of the plurality of tax structures, and
wherein the statistical measure comprises a number of users among the plurality of users who have performed the pre-determined task based on the tax structure pattern.

8. The method of claim 1, further comprising:
identifying the plurality of users based on a tax structure pattern that is same for each of the plurality of tax structures,
wherein the tax structure pattern comprises every tax rate included in each of the plurality of tax structures, and
wherein the statistical measure comprises a number of times that the plurality of users have performed the pre-determined task based on the tax structure pattern.

9. The method of claim 1, further comprising analyzing the plurality of tax structures to identify a tax structure pattern by:
determining that every tax structure of the plurality of tax structures comprises a same number of tax rates and a same total tax rate, wherein the same total tax rate comprises a sum of every tax rate in any one of the plurality of tax structures, wherein each tax rate in a particular tax structure of the plurality of tax structures is identified by a user defined tax label specific to the particular tax structure; and
analyzing, in response to the determining, the user defined tax label for every tax rate in the plurality of tax structures that has a same percentage value to identify a plurality of tax categories,
wherein each of the plurality of tax categories represents a plurality of user defined tax labels that are semantically equivalent with respect to the tax jurisdiction requirement of the geographical region and identify a same one of the tax rates and,
wherein each of the plurality of user defined tax labels that are semantically equivalent is specific to one of the plurality of tax structures,
wherein the tax structure pattern comprises a sequence of tax rates each associated with one of the plurality of tax categories,
wherein the statistical measure is based at least on the tax structure pattern, and
wherein the suggested tax structure comprises the tax structure pattern and a tax label for each of the plurality of tax categories to represent a respective tax dictated by the tax jurisdiction requirement of the geographical region.

10. The method of claim 9, wherein the statistical measure comprises:
a number of registered users who have paid for the software application;
a number of users among the plurality of users who have performed the pre-determined task based on the same total tax rate;
a number of users among the plurality of users who have performed the pre-determined task based on the tax structure pattern; and
a number of times that the plurality of users has performed the pre-determined task based on the tax structure pattern.

11. The method of claim 9, further comprising:
generating, based at least on another tax structure pattern, another statistical measure of the plurality of users and another number of times the pre-determined task is performed by the plurality of users, wherein the tax structure pattern and the another tax structure pattern correspond to a first type of taxable transaction and a second type of taxable transaction, respectively;
generating, in response to the another statistical measure exceeding the pre-determined threshold, another suggested tax structure based on the another tax structure pattern; and
presenting the another suggested tax structure to another new user of the software application, wherein the another suggested tax structure is used by the another new user to configure another new instantiation of the software application for performing the pre-determined task for the second type of taxable transaction.

12. The method of claim 9, further comprising:
generating, based at least on another tax structure pattern, another statistical measure of another plurality of users and another number of times the pre-determined task is performed by the another plurality of users, wherein the tax structure pattern and the another tax structure pattern correspond to a first user industry and a second user industry, respectively;
generating, in response to the another statistical measure exceeding the pre-determined threshold, another suggested tax structure based on the another tax structure pattern; and
presenting, in response to at least determining that another new user of the software application is associated with the second user industry, the another suggested tax structure to the another new user, wherein the another suggested tax structure is used by the another new user to configure another new instantiation of the software application for performing the pre-determined task.

13. The method of claim 1, further comprising:
obtaining another plurality of tax structures generated by another plurality of users according to another tax jurisdiction requirement of another geographical region, wherein each of the another plurality of tax structures comprises another tax rate that is used by the another plurality of users to configure another plurality of instantiations of the software application for performing the pre-determined task, wherein performing the pre-determined task within the another geographical region comprises at least calculating another tax amount based on the another tax rate;
generating another statistical measure of the another plurality of users and another number of times the pre-determined task is performed by the another plurality of users;
generating, in response to the another statistical measure exceeding the pre-determined threshold, another suggested tax structure to represent another portion of the another plurality of tax structures; and
presenting the another suggested tax structure to the another new user of the software application, wherein the another suggested tax structure is used by the another new user to configure another new instantiation of the software application for performing the pre-determined task within the another geographical region.

14. The method of claim 1, wherein generating the plurality of tax structures by the plurality of users comprises:
receiving, by an instantiation of the plurality of instantiations to perform the pre-determined task, an input from a user of the plurality of users to select between manually creating a new tax structure or using a tax structure suggestion function of the software application; and
generating, by the instantiation of the software application and in response to the user selecting to manually create the new tax structure, one of the plurality of tax structures based on further inputs from the user,
wherein presenting the suggested tax structure to the new user is in response to the new user selects to use the tax structure suggestion function.

15. A system to generate a suggested tax structure in a software application for a geographical region, comprising:
a tax structure analyzer executing on a computer processor and configured to:
obtain a plurality of tax structures generated by a plurality of users according to a tax jurisdiction requirement of the geographical region,
wherein each of the plurality of tax structures comprises a tax rate that is used by the plurality of users to configure a plurality of instantiations of the software application for performing a pre-determined task, and
wherein performing the pre-determined task within the geographical region comprises at least calculating a tax amount based on the tax rate;
generate a statistical measure of the plurality of users and a number of times the pre-determined task is performed by the plurality of users; and
generate, in response to the statistical measure exceeding a pre-determined threshold, a suggested tax structure to represent a portion of the plurality of tax structures that is qualified based on the statistical measure;
a user device coupled to the computer processor and configured to:
present, in response to at least determining that a new user of the software application is within the geographical region, the suggested tax structure to the new user, wherein the suggested tax structure is used by the new user to configure a new instantiation of the software application for performing the pre-determined task within the geographical region; and
a repository configured to store the statistical measure and the suggested tax structure.

16. The system of claim 15, the tax structure analyzer further configured to:
identify the plurality of users based on an industry designation in a user profile of each of the plurality of users.

17. The system of claim 15, wherein the pre-determined task further comprises generating, based on the tax amount, at least one selected from a group consisting of an invoice, a purchase order, an accounting report, and a tax agency filing.

18. The system of claim 15, wherein the statistical measure comprises a number of registered users who have paid for the software application.

19. The system of claim 15, the tax structure analyzer further configured to:
identify the plurality of users based on a total tax rate that is same for each of the plurality of tax structures,
wherein the total tax rate comprises a sum of every tax rate included in each of the plurality of tax structures, and
wherein the statistical measure comprises a number of users among the plurality of users who have performed the pre-determined task based on the total tax rate.

20. The system of claim 15, the tax structure analyzer further configured to:
identify the plurality of users based on a total tax rate that is same for each of the plurality of tax structures,
wherein the total tax rate comprises a sum of every tax rate included in each of the plurality of tax structures, and
wherein the statistical measure comprises a number of times that the plurality of users have performed the pre-determined task based on the total tax rate.

21. The system of claim 15, the tax structure analyzer further configured to:
identify the plurality of users based on a tax structure pattern that is same for each of the plurality of tax structures,
wherein the tax structure pattern comprises every tax rate included in each of the plurality of tax structures, and
wherein the statistical measure comprises a number of users among the plurality of users who have performed the pre-determined task based on the tax structure pattern.

22. The system of claim 15, the tax structure analyzer further configured to:
identify the plurality of users based on a tax structure pattern that is same for each of the plurality of tax structures,
wherein the tax structure pattern comprises every tax rate included in each of the plurality of tax structures, and
wherein the statistical measure comprises a number of times that the plurality of users have performed the pre-determined task based on the tax structure pattern.

23. The system of claim 15, the tax structure analyzer further configured to analyze the plurality of tax structures to identify a tax structure pattern by:
determining that every tax structure of the plurality of tax structures comprises a same number of tax rates and a same total tax rate, wherein the same total tax rate comprises a sum of every tax rate in any one of the plurality of tax structures, wherein each tax rate in a particular tax structure of the plurality of tax structures is identified by a user defined tax label specific to the particular tax structure; and
analyzing, in response to the determining, the user defined tax label for every tax rate in the plurality of tax structures that has a same percentage value to identify a plurality of tax categories,
wherein each of the plurality of tax categories represents a plurality of user defined tax labels that are semantically equivalent with respect to the tax jurisdiction requirement of the geographical region and identify a same one of the tax rates,
wherein each of the plurality of user defined tax labels that are semantically equivalent is specific to one of the plurality of tax structures,
wherein the tax structure pattern comprises a sequence of the tax rates each associated with one of the plurality of tax categories,
wherein the statistical measure is based at least on the tax structure pattern, and
wherein the suggested tax structure comprises the tax structure pattern and a tax label for each of the plurality of tax categories to represent a respective tax dictated by the tax jurisdiction requirement of the geographical region.

24. The system of claim 23, wherein the statistical measure comprises:
a number of registered users who have paid for the software application;
a number of users among the plurality of users who have performed the pre-determined task based on the same total tax rate;
a number of users among the plurality of users who have performed the pre-determined task based on the tax structure pattern; and
a number of times that the plurality of users has performed the pre-determined task based on the tax structure pattern.

25. The system of claim 23, the tax structure analyzer further configured to:
generate, based at least on another tax structure pattern, another statistical measure of the plurality of users and another number of times the pre-determined task is performed by the plurality of users, wherein the tax structure pattern and the another tax structure pattern correspond to a first type of taxable transaction and a second type of taxable transaction, respectively;
generate, in response to the another statistical measure exceeding the pre-determined threshold, another suggested tax structure based on the another tax structure pattern; and
present the another suggested tax structure to another new user of the software application, wherein the another suggested tax structure is used by the another new user to configure another new instantiation of the software application for performing the pre-determined task for the second type of taxable transaction.

26. The system of claim 23, wherein the tax structure analyzer is further configured to:
generate, based at least on another tax structure pattern, another statistical measure of another plurality of users and another number of times the pre-determined task is performed by the another plurality of users, wherein the tax structure pattern and the another tax structure pattern correspond to a first user industry and a second user industry, respectively; and
generate, in response to the another statistical measure exceeding the pre-determined threshold, another suggested tax structure based on the another tax structure pattern,
wherein the system further comprises another user device configured to present, in response to at least determining that another new user of the software application is associated with the second user industry, the another suggested tax structure to the another new user, wherein the another suggested tax structure is used by the another new user to configure another new instantiation of the software application for performing the pre-determined task.

27. The system of claim 15, wherein the tax structure analyzer is further configured to:
obtain another plurality of tax structures generated by another plurality of users according to another tax jurisdiction requirement of another geographical region, wherein each of the another plurality of tax structures comprises another tax rate that is used by the another plurality of users to configure another plurality of instantiations of the software application for performing the pre-determined task, wherein performing the pre-determined task within the another geographical region comprises at least calculating another tax amount based on the another tax rate;
generate another statistical measure of the another plurality of users and another number of times the pre-determined task is performed by the another plurality of users; and
generate, in response to the another statistical measure exceeding the pre-determined threshold, another suggested tax structure to represent another portion of the another plurality of tax structures,
wherein the system further comprises another user device configured to present the another suggested tax structure to the another new user of the software application, wherein the another suggested tax structure is used by the another new user to configure another new instantiation of the software application for performing the pre-determined task within the another geographical region.

28. The system of claim 15, wherein generating the plurality of tax structures by the plurality of users comprises:
receiving, by an instantiation of the plurality of instantiations to perform the pre-determined task, an input from a user of the plurality of users to select between manually creating a new tax structure or using a tax structure suggestion function of the software application; and
generating, by the instantiation of the software application and in response to the user selecting to manually create the new tax structure, one of the plurality of tax structures based on further inputs from the user,
wherein presenting the suggested tax structure to the new user is in response to the new user selects to use the tax structure suggestion function.

29. A non-transitory computer readable medium storing instructions to generate a suggested tax structure in a software application for a geographical region, the instructions, when executed by a computer processor, comprising functionality for:
obtain a plurality of tax structures generated by a plurality of users according to a tax jurisdiction requirement of the geographical region,
wherein each of the plurality of tax structures comprises a tax rate that is used by the plurality of users to configure a plurality of instantiations of the software application for performing a pre-determined task, and
wherein performing the pre-determined task within the geographical region comprises at least calculating a tax amount based on the tax rate;
generate a statistical measure of the plurality of users and a number of times the pre-determined task is performed by the plurality of users;
generate, in response to the statistical measure exceeding a pre-determined threshold, a suggested tax structure to represent a portion of the plurality of tax structures that is qualified based on the statistical measure; and
present, in response to at least determining that a new user of the software application is within the geographical region, the suggested tax structure to the new user, wherein the suggested tax structure is used by the new user to configure a new instantiation of the software application for performing the pre-determined task within the geographical region.
